(19) United States
(12) Patent Application Publication
(10) Pub. No.: US 2003/0187672 A1
(43) Pub. Date: Oct. 2, 2003

(54) Method, system, and program for servicing customer product support requests

(75) Inventors: Kenneth J. Gibson, Lafayette, CO (US); Daniel J. Maslowski, Erie, CO (US); Joan Elizabeth Prebish, Louisville, CO (US)

Correspondence Address: David W. Victor, KONRAD RAYNES VICTOR & MANN LLP, Suite 210, 315 S. Beverly Drive, Beverly Hills, CA, 90212, US

(73) Assignee: Sun Microsystems, Inc.

(21) Appl. No.: 10/113,055

(22) Filed: Apr. 1, 2002

(51) Int. Cl. G06F 17/60

(52) U.S. Cl. 705/1

(57) ABSTRACT

Provided are a method, system, and program for servicing customer requests for at least one product. At least one queue is maintained in a service computer indicating at least one customer requesting product support for the at least one product. Requests for customer service are received from customer computers used by customers over a network. Transmitted to the customer computers of customers indicated in the queue is chat session content between a technical support agent and one customer indicated in the queue.

### BACKGROUND OF THE INVENTION

1. Field of the Invention

The present invention relates to a method, system, and program for servicing customer product support requests.

2. Description of the Related Art

Vendors of computer related and other products often provide different channels of customer support. For certain products, vendors will provide telephone support from a technician over the phone. Many other vendors provide on-line technical support available over the Internet in addition to telephone support. For instance, companies often provide on-line Internet access to a knowledge database that may be searched to locate articles providing solutions to common problems. Many companies also provide online newsgroups or message boards where users may post messages about a problem and wait for another user to post a response providing a solution to the problem.

Many customer related problems occur upon the release of a new product version or upgrade. At such points in time, the vendor's customer support phone lines are often deluged with phone calls for product support. Further, with product upgrades, because problems may be relatively new and the vendor has not had a chance to verify or confirm solutions, the online technical support features, such as the searchable knowledge databases and bulletin boards, may not yet have adequate fixes to the problems. Those in the computer industry have noticed that approximately 80% of customer technical problems due to a new upgrade are commonly experienced.

There is thus a need in the art to provide improved systems for customer support services and providing customers information on technical problems.

### SUMMARY OF THE PREFERRED EMBODIMENTS

Provided are a method, system, and program for servicing customer requests for at least one product. At least one queue is maintained in a service computer indicating at least one customer requesting product support for the at least one product. Requests for customer service are received from customer computers used by customers over a network. Transmitted to the customer computers of customers indicated in the queue is chat session content between a technical support agent and one customer indicated in the queue.

In further implementations, a list of all customers indicated in the queue is generated and transmitted to the customer computers of customers indicated in the queue, wherein the list is rendered on the customer computers.

Still further, one indicated customer is selected from the queue and one technical support agent is selected. A chat session is enabled between the customer computer of the selected customer and an agent computer of the selected technical support agent, wherein other queued customers can observe the chat session between the selected customer and technical support agent.

Yet further, a customer request for product support from one customer computer is received over the network and one of the queues is selected. An entry is added to the selected queue indicating the customer requesting product support.

At least one queue may be associated with each of a plurality of products for which customer support is provided. In such case, selecting one of the queues comprises determining a product indicated in the customer request for product support and selecting one queue associated with the determined product.

Further provided are a method, system, and program for receiving customer support for a product at a customer computer. A request for product support is transmitted from the customer computer to a service computer over a network. In response to the request, chat session content between a technical support agent and another customer is received.

Described implementations concern a system and communication interface for providing product support to customers over a computer network. With the described implementations, customers waiting to speak with a technical support agent are placed in a queue. The queued customers may observe a real-time chat session between one customer in the queue and the technical support agent. In certain implementations, the queued customers as well as technical support agents servicing the queue may access support resources through a page in which the chat session content is also rendered. In this way, customers may observe a potential solution to their problem discussed in the chat session while waiting in the queue. This will allow customers to quit from the queue to implement the solution, thereby reducing wait times for other queued customers and improving overall service.

### BRIEF DESCRIPTION OF THE DRAWINGS

Referring now to the drawings in which like reference numbers represents corresponding parts throughout:

FIG. 1 illustrates a network computing environment in which aspects of the invention are implemented;

FIG. 2 illustrates data structures in a customer database in accordance with implementations of the invention;

FIG. 3 illustrates a data structure of a queued customer request in accordance with implementations of the invention;

FIG. 4 illustrates a customer page displayed at a customer computer in accordance with implementations of the invention;

FIG. 5 illustrates a technical support agent page displayed at a technical support agent computer in accordance with implementations of the invention;

FIGS. 6-9 illustrates logic to service customer support requests in accordance with implementations of the invention; and

FIG. 10 illustrates a computer architecture that may be used with certain implementations of the computer systems described in FIG. 1.

### DETAILED DESCRIPTION OF THE PREFERRED EMBODIMENTS

In the following description, reference is made to the accompanying drawings which form a part hereof, and which illustrate several embodiments of the present invention. It is understood that other embodiments may be utilized and structural and operational changes may be made without departing from the scope of the present invention.

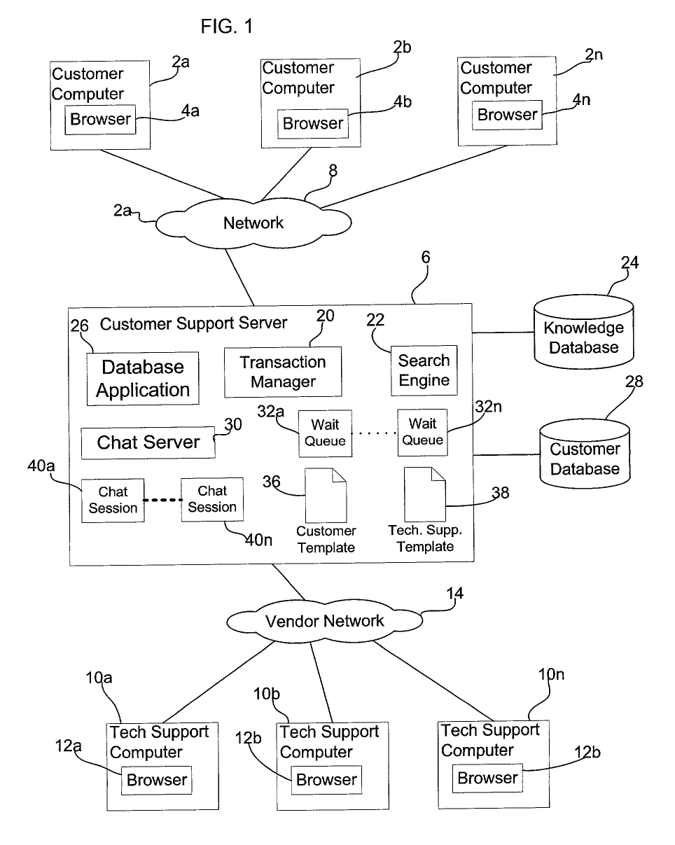

FIG. 1 illustrates a network computing environment in which aspects of the invention are implemented. A plurality of customer computers 2a, 2b . . . 2n, each including a browser program 4a, 4b . . . 4n, communicate with a customer support server 6 over a network 8, such as the Internet, Intranet, Virtual Private Network (VPN), Local Area Network (LAN), Wide Area Network (WAN), etc. The client computers 2a, 2b . . . 2n are operated by registered customers of a device or product sold by a vendor that operates the customer support server 4 to provide support to users. The supported devices may comprise computer hardware, computer software, appliances or any other product or device requiring service. In the described implementations, the devices are described as being computer hardware and software. The client computers 2a, 2b . . . 2n may comprise any computer device known in the art, such as a desktop, workstation, mainframe, server, hand held computer, laptop, telephony device, etc. The browser 4a, 4b . . . 4n may comprise any application program capable of accessing data from over a network and rendering such data to the user of the computer 2a, 2b . . . 2n, such as a Hypertext Markup Language (HTML) browser capable of rendering content coded in HTML, the Extensible Markup Language (XML), Scalable Vector Graphics (SVG), etc. The customer support server 6 may comprise one or more computing devices designed to handle requests from clients over a network for files.

A plurality of technical support computers 10a, 10b . . . 10n are used by technical support agents to communicate with the customer computers 2a, 2b . . . 2n. Each of the technical support computers 10a, 10b . . . 10n include a browser 12a, 12b . . . 12n to display content generated by the customer support server 6. The technical support computers 10a, 10b . . . 10n communicate with the customer support server 6 via a network 14, which may comprise an internal vendor network, such as a LAN, VPN, Intranet, etc. Alternatively, some of the technical support computers 10a, 10b . . . 10n may communicate with the customer support server 6 via the Internet. Thus, the network 14 may comprise a different network than the network 8, or the same network. Alternatively, the networks 8 and 14 may comprise multiple networks, such that customer computers 2a, 2b . . . 2n and technical support computers 10a, 10b . . . 10n may use multiple different channels to communicate with the customer support server 6.

The customer support server 6 includes various programs and components to manage the communications between the customer computers 2a, 2b . . . 2n and the technical support computers 10a, 10b . . . 10n. For instance, the customer support server 6 includes a transaction manager 20, which performs the general request processing of customer service requests, routes the requests and calls the appropriate services. The transaction manager 20 may comprise a single program, or a plurality of programs, such as components in a workflow model or one or more servlets, to perform operations described herein. The customer support server 6 further includes a search engine 22 to execute customer searches of a knowledge database 24, which includes indexed and searchable technical support articles and documents. A database application 26 is used to query and maintain customer records in a customer database 28. The database application 26 may comprise any relational or object oriented database application program known in the art. A chat server 30 enables the establishment of real-time chat communication channels between the customer 2a, 2b . . . 2n and technical support 10a, 10b . . . 10n computers. A “chat” comprises real-time communication between two users, where either user can enter text by typing on the keyboard or through another input mechanism and the entered text will appear on the other user's monitor. The term “chat” further includes other real time communication transmitted through a computer network other than text communication, such as voice, video, etc. A plurality of wait queues 32a . . . 32n are used to queue customer requests for product support for a particular product. Associated with each queue 32a . . . 32n is a chat session 40a . . . 40n which lists all customers in the queue that will receive chat content for that queue.

The customer support server 6 further maintains customer templates 36, in which the transaction manager 20 adds variable information to return to the customer computers 2a, 2b . . . 2n in response to customer requests and returns technical support templates 38 with added variable information to the technical support computers 10a, 10b . . . 10n in response to requests from the technical support agents. The transaction manager 20 may update pages displayed in the technical support browsers 12a, 12b . . . 12n and customer browsers 4a, 4b . . . 4n with the variable information.

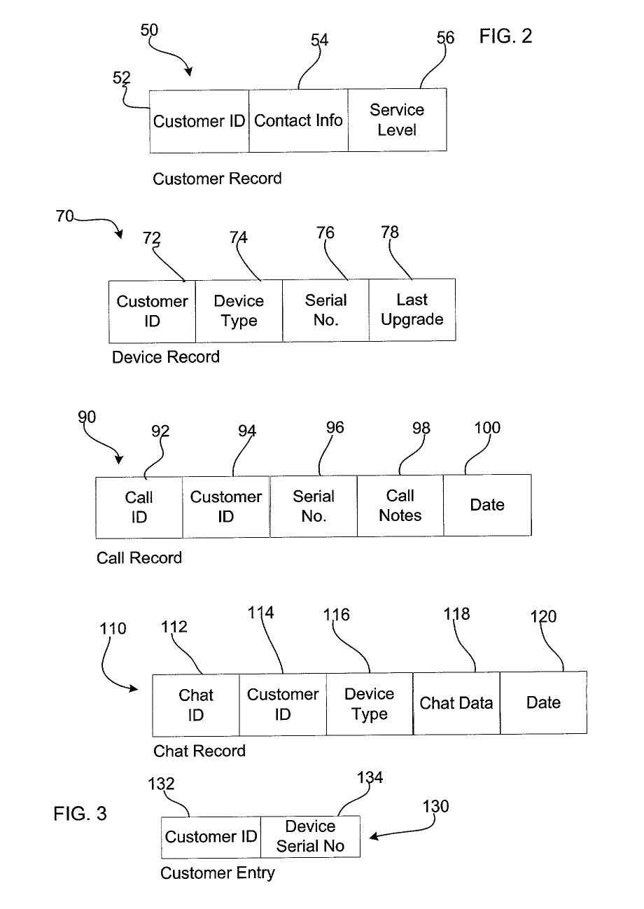

FIG. 2 illustrates records maintained in the customer database 28. For each customer there is a customer record 50, including a unique customer identifier (ID) 52, customer contact information 54, and a service level 56 indicating the level of service the customer has contracted to receive, e.g., gold level, silver, bronze, etc. For each device a customer purchases from the vendor, there is a device record 70. Each device record 70 includes a customer identifier 72 of the customer that purchased the device, a device type 74, a unique serial number 76 of the device, and the last upgrade 78, e.g., software upgrade, firmware upgrade, etc., the customer downloaded for the device. For each time a customer communicates with a technical support person, a call record 90 is added to the customer database 28, including a unique call identifier (ID) 92, the customer identifier 94 of the customer that initiated the communication, a serial number 96 of the device that was the subject of the communication, and call notes 98 providing any information on the content of the call. The call notes 98 may be entered by the technical support personnel. For each chat session established between a customer and technical support person, a chat record 110 is added, including a unique chat identifier 112, the customer ID 114 of the customer that is communicating in the chat, the serial number 116 of the device subject to the chat, and the actual chat data 118 generated by the parties during the chat. Note that the records 50, 70, 90, and 110 described above are one way to implement the content of the customer database 28. However, in alternative implementations, additional fields may be added, and information may be consolidated into fewer or a greater number of fields. Further, with the described record data structure, the records may be searched according to a particular customer identifier to determine all products, calls, chats, etc. for a particular customer. Alternatively, chats and call records can be searched by device type, or the call notes 98 and chat data 118 can be searched by keywords to locate chats and calls directed toward a particular topic.

FIG. 3 illustrates an example of the format of the entries 130 in the queues 32a . . . 32n. Each entry would include a customer ID 132 of the customer that was added to the queue and the unique serial number 134 of the product that is the subject of the query.

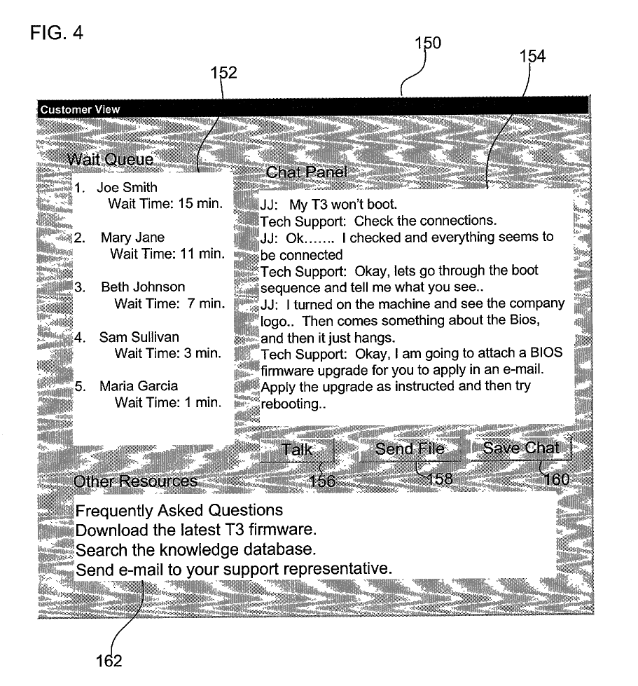

FIG. 4 illustrates an example of a customer page 150 that would be displayed in the customer browser 4a, 4b . . . 4n in response to a customer request for product support for a specific device. The customer page 150 displays a wait queue panel 152 that includes a list of all customers waiting in the queue 32a . . . 32n in which the customer receiving the page 150 is entered. The wait queue panel 152 may display estimated wait times. A chat panel 154 displays the content of a chat session between one customer and the technical support agent. A customer waiting in the queue 32a . . . 32n could observe in the chat panel 154 a chat session involving another customer in the same queue 32a . . . 32n. For a customer that is chatting, the chat panel 154 may display the data the customer and technical support agent input during the chat session. The customer who is being serviced, may select the talk button 156 to begin the chat. In certain implementations, the talk button 156 would not be enabled in the page 150 displayed for a queued customer that is waiting and viewing the chat of another customer. The customer can send a file by selecting the send file button 158. For instance, the technical support agent may request certain information or files. The customer may also save the entire conversation by selecting the save log 160. An “Other Resources” panel 162 provides links, such as hypertext links, to other resources, such as a Frequently Asked Questions (FAQ) list, the option of downloading the recent upgrade (if applicable), sending an email to another customer support representative, searching the knowledge database 24, etc. Additional options may also be provided.

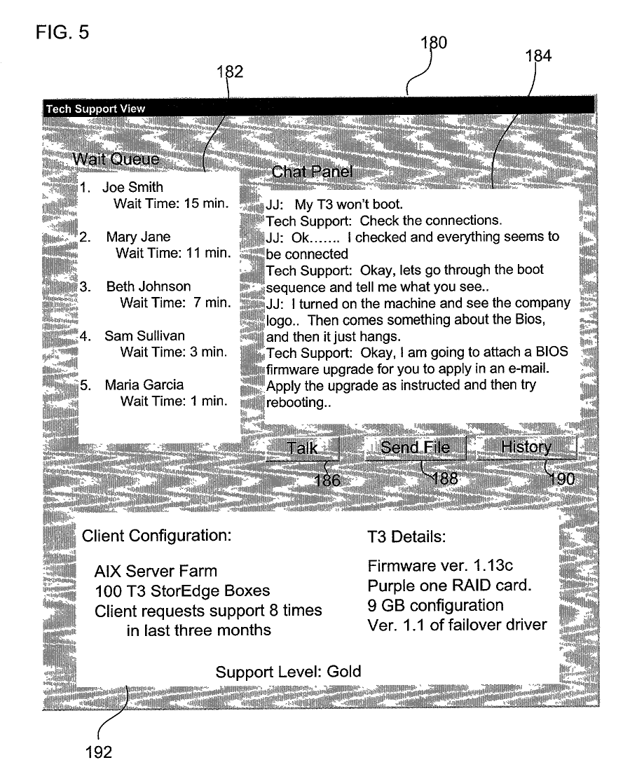

FIG. 5 illustrates an example of a page 180 that would be displayed in the technical support agent browser 12a, 12b . . . 12n for use by the technical support agent when providing customer support. The technical support page 180 displays a queue panel 182 based on the current status of customer entries in the queue in 32a . . . 32n, which in certain implementations may be similar to what is displayed in the wait queue 152 in the customer page 150. In certain implementations, each support agent is assigned to handle requests for one queue 32a . . . 32n. Such assignments and routing of queued customers to technical support computers 10a, 10b . . . 10n may be handled by the transaction manager 20. A chat panel 184 displays the chat content between one customer and the technical support agent. The technical support agent may participate in the chat by observing customer entered comments in the panel 184 and directly inputting responses in the chat panel 184 in real time. The support agent may select the talk button 186 to begin the chat. The support agent may select the “Send File” button 188 to send a file directly to the customer the agent is corresponding with in the chat panel 184, such as through a send attachment mechanism in the chat program or through an e-mail to the customer. Selection of the history button 190 would display customer support information for the customer. This information may be gathered from the call notes field 98 in the call records 90 for that customer, queried on the customer ID 94. The history list may display a list of customer call incidents as hypertext that when selected lead to the call notes 98 content describing that customer support session.

A client configuration panel 192 displays information on the client configuration, such as the general configuration, e.g., an AIX Server Farm, the purchased products, e.g., Sun Microsystems StoreEdge T3 disk array, and recent call history (which may be gleaned from the call records 90). The T3 details section provides information on the T3 disk array devices of the customer, such as their firmware level, which may be obtained from the last upgrade 76 field of the device records 70 for the customer, the hardware configuration, and any other device information maintained with the device records 70. The technical support view 180 further displays the support level of the customer, which is obtained from the service level field 56 of the customer record 52.

FIGS. 4 and 5 illustrate one possible implementation of the layout of the customer and technical support pages. Those skilled in the art will appreciate that the layout of the presentation of the information in the views may differ as well as the type of information displayed. The information included in the views 150 and 180 is gathered by the transaction manager 20 using the database application 26 to query the customer database 28 for information as well as the chat server 30 to enable communication between the chat panels 154 and 184 in the displayed pages 150 and 180. The customer page 150 may be generated from the customer template 36 and the technical support page 180 generated from the technical support template 38. Further, the panels displayed in the pages may be implemented with any coding technique in the art, such as HTML frames or another mechanism in which information is displayed and separately updated.

As discussed, the customer support server 6 maintains a plurality of wait queues 32a . . . 32n to implement a queuing system for customer requests on a First-In-First-Out (FIFO) basis for each queue 32a . . . 32n. A separate queue may be provided for each product that is separately supported. In this way, technical support agents with particular expertise in a specific product will handle requests from the queue designated for such product. Further, within each product, there may be separate queues 32a . . . 32n for the different support levels. For instance, a queue provided for customers that have purchased the highest support level may have a greater number of available technical support agents assigned to that queue over queues associated with requests from customers contracting at a lower support level in order to provide a more timely response to customers at the highest support level.

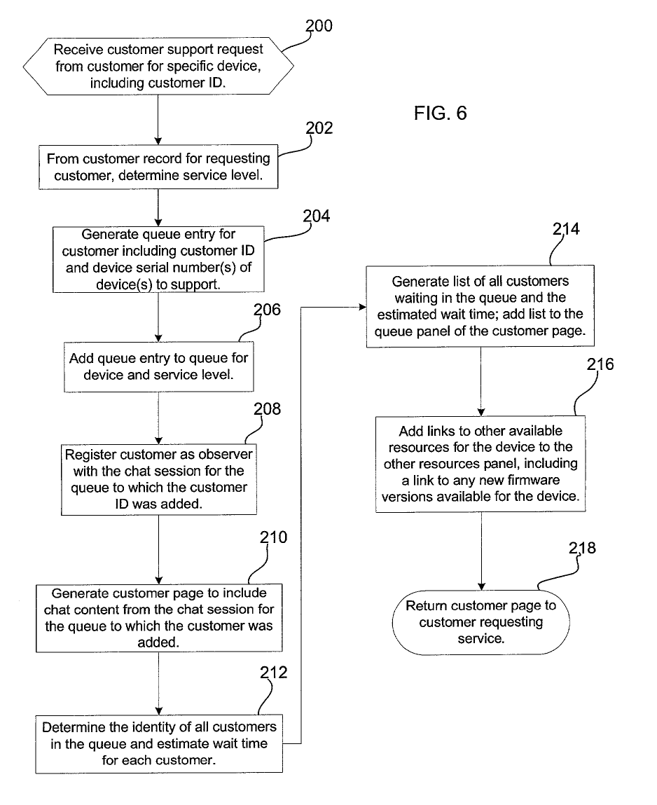

FIGS. 6-9 illustrate logic implemented in the transaction manager 20 to implement a customer support system where customer service requests from customer computers 2a, 2b . . . 2n are handled at technical support computers 10a, 10b . . . 10n. FIG. 6 illustrates the logic to handle a customer request for support for a purchased device. At block 200, the transaction manager 20 receives a customer request for support for a specific device, including the unique customer identifier. This request may have been generated from a previous page transmitted to the customer that provides fields in which the customer enters information, such as the customer ID and product for which support is requested and/or the unique number of the product. The transaction manager 20 would then query (at block 202) the customer records 50 in the customer database 28, using the database application 26, to determine the service level 56 for the specified customer ID 52. A queue entry 130 is then generated (at block 204) for the customer including the unique customer identifier 132 and the serial number 134 of the device which is the subject of the service request. In certain implementations, if the customer is inquiring about multiple instances of the same device, then the serial number field 134 may specify multiple serial numbers for the multiple instances of the particular device subject to the service inquiry. The transaction manager 20 would then add (at block 206) the generated queue entry to the specific queue 32a . . . 32n that queues requests for a particular device and/or support level. As discussed, in certain implementations, a separate queue may be provided for each device type and support level to ensure that the technical support agent has expertise for the device being supported, which is especially important for vendors that sell substantially different product types, and to ensure that customers receive support commensurate with the service level they have purchased.

The customer would further be registered (at block 208) as a non-participating observer of the chat session 40a . . . 40n associated with the particular queue 32a . . . 32n to which the customer is assigned. Registering the user with a particular chat session 40a . . . 4n causes the chat server 30 to allow the customer to observe the current chat stream for the particular chat session 40a . . . 40n. The transaction manager 20 generates (at block 210) a customer page from the customer template 36 to include the chat content from the chat session 40a . . . 40n to which the customer was added. The identity of all the customers queued in the queue 32a . . . 32n to which the customer added is determined (at block 212) and a wait time is estimated. The wait time may be based on an empirically determined wait time per queued customers in general or for a particular product and/or service level. The transaction manager 20 then generates (at block 214) a list of all the customers waiting in the queue and their corresponding estimated wait time and adds the list to the queue panel 152 in the customer page 150 (FIG. 4) being generated. Links, such as hypertext lins, to additional resources, such as a page to access the search engine 22 to search the knowledge database 24, a list of frequently asked questions, a firmware upgrade, etc., are then added (at block 216) to the other resources panel 162 in the customer page 150 being generated. The generated customer page 150 is then returned (at block 218) to the customer browser 4a, 4b . . . 4n that initiated the service request. If the page 150 is encoded in HTML, then the page may include a refresh metatag to cause the customer browser 4a, 4b . . . 4n to reload the page periodically, which would trigger the logic of FIG. 6 to cause the transaction manager 20 to regenerate the page with any updated data. Further, the chat panel 152 enables the customer page 150 to receive real-time chat session 40a . . . 40n content between a customer in the queue 32a . . . 32n and a technical support agent.

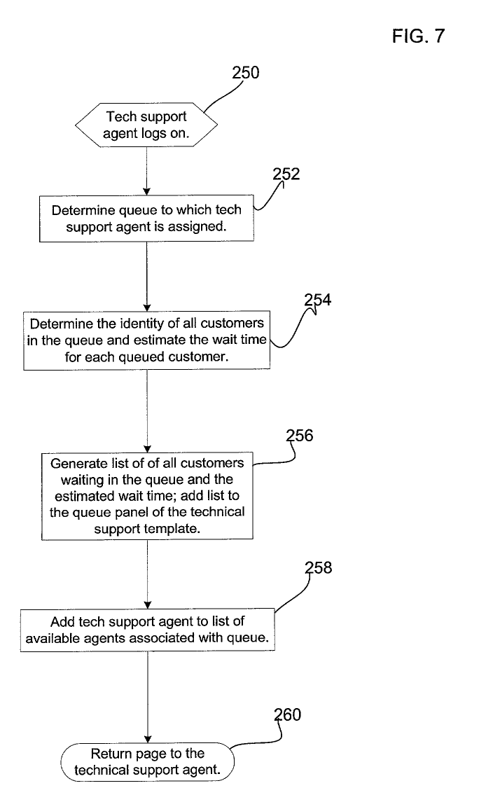

FIG. 7 illustrates logic implemented in the transaction manager 20 to assign and make available a technical support agent to handle customer service requests from the wait queues 32a . . . 32n. In response to a customer support agent beginning a session (at block 250) with the customer support server 6 from a technical support computer 10a, 10b . . . 10n over the network 14, the transaction manager 20 determines (at block 252) the queue 32a . . . 32n to which the technical support agent is assigned. As discussed, agents may be assigned to queues having requests for a particular product and/or support level for which the agent has expertise. Alternatively, the assignment may be based on need, such that agents are assigned to the queues having the longest wait lists and estimated wait times. The transaction manager 20 determines (at block 254) the identity of all the customers queued in the queue 32a . . . 32n to which the agent is assigned and a wait time is estimated for each queued customer. The transaction manager 20 then generates (at block 256) a list of all the customers waiting in the queue and their corresponding estimated wait time and adds the list to the queue panel 182 in the technical support page 180 (FIG. 5) being generated from a technical support template 38 (FIG. 1). The technical support page 180 may also include a refresh tag, such as the HTML refresh metatag described with respect to the customer page 150, to cause the technical support browser 12a, 12b . . . 12n to reload the page periodically. The technical support agent assigned to the queue 32a . . . 32n is then added (at block 258) to a list of agents assigned to that particular queue. The technical support page 180 is returned (at block 260) to the agent that initiated the session.

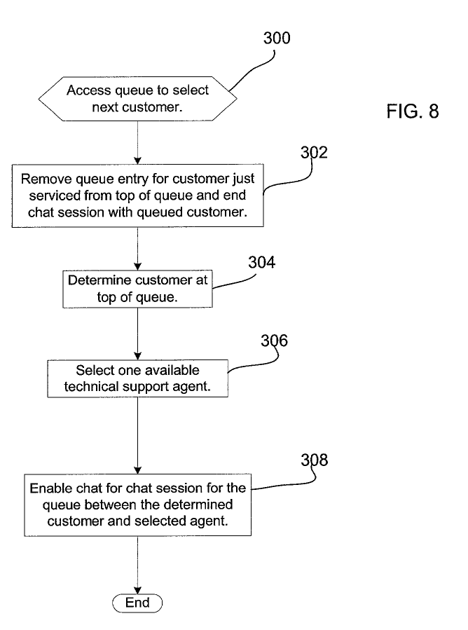

FIG. 8 illustrates logic implemented in the transaction manager 20 to service customer support requests from the queues 32a . . . 32n. Control begins at block 300 to access a next queued customer entry 130 (FIG. 3) in one queue, e.g., queue 32a. The logic at block 300 may be initiated in response to ending a session with one queued customer or processing a first queue entry being added to the queue 32a. If the technical support agent has completed servicing one customer, then the queue entry 130 for that customer is removed (at block 302) from the top of the queue 32a, and the chat session 40a with that queued customer is ended. The next queued customer entry in the queue 32a is determined (at block 304), which in certain implementations is determined on a FIFO basis, and a customer support agent associated with the queue 32a being processed is selected (at block 306). The selected technical support agent may be the one that completed servicing a customer or another agent associated with the queue 32a. Alternatively, if technical support agents assigned to other queues, e.g., queues 32b . . . 32n, have been idle, they may be selected. If there is no available technical support agent, then selection of a technical support agent and the process of FIG. 8 may be delayed until an agent becomes available. The transaction manager 20 then calls the chat server 30 to configure (at block 308) the chat session 40a to enable direct chatting between the selected technical support agent and the determined customer. Once the chat session is enabled, the technical support agent and customer may then communicate to resolve the customer technical problem via the chat panels 154 and 184 in their respective pages 150 and 180 rendered in their respective browsers 4a, 4b . . . 4n and 12a, 12b . . . 12n. Others still in the queue 32a may observe the chat session between the selected customer and the technical support agent in real time.

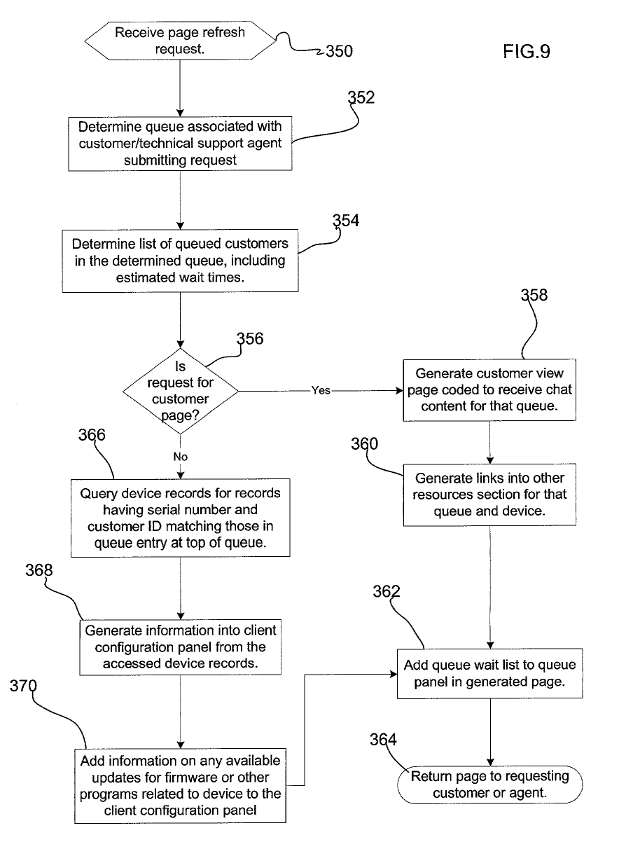

FIG. 9 illustrates logic implemented in the transaction manager 20 to provide the customer browsers 4a, 4b . . . 4n and technical support browsers 12a, 12b . . . 12n updated information. As discussed, in certain implementations, the customer and technical support pages 150 and 180 are coded with refresh tags, which cause the customer and technical support browsers to periodically request the page 150 and 180, so that the transaction manager 20 may generate and return a new page with any updated information. Those skilled in the art will appreciate that there may be alternative ways to provide the customer and technical support browsers with updated information in addition to using the refresh tag technique described herein. For instance, the pages 150 and 180 may include a refresh button, which the user may select to cause the page to be reloaded and obtain any updated information. Control begins at block 350 with the transaction manager 20 receiving a refresh request. A discussed, in pull systems, such as those that utilize the HTML refresh metatag, the refresh request may be initiated by the customer or technical support browser. Alternatively, in push systems, the transaction manager 20 may itself generate the refresh request to push updated information to the customer and technical support browsers.

In response to the refresh request (at block 350), the transaction manager 20 determines (at block 352) the queue 32a . . . 32n associated with the customer/technical support agent submitting the request, or for which the refresh request is generated. A list of customers queued in the determined queue 32a . . . 32n is generated (at block 354), along with the estimated wait times. Such information may be determined from the customer entries 130 in the determined queue 32a . . . 32n. If (at block 356) the refresh request is for a customer page 150, then the transaction manager 20 generates (at block 358) from the customer template 36 a customer page 150 with the chat panel 154 to receive chat content from the chat session 40a . . . 40n for the queue in which the customer is entered. Links are generated (at block 360) into the other resources panel 162 to provide hypertext or other access to additional information, such as frequently asked questions, firmware downloads, the knowledge database 24, etc. The queue wait list and estimated times are then added (at block 362) to the wait queue panel 152 and the generated customer page 150 is returned (at block 364) to the customer browser 4a, 4b . . . 4n requesting the refresh.

If (at block 356) the request to refresh the page is for a technical support agent browser 12a, 12b . . . 12n, then the transaction manager 20 calls (at block 366) the database application 26 to query the device records 70 in the customer database 28 for records having a serial number and customer ID matching those in the customer entry 130 (FIG. 3) at the top of the wait queue 32a . . . 32n. The transaction manager 20 further generates (at block 368) information into the configuration panel 192 of the technical support page 180 (FIG. 5) from the accessed device records 70 concerning the device configuration of the device being serviced, such as number of devices, number of support requests, general system environment, current firmware version, etc. Further, any information on firmware or other updates are added (at block 370) to the client configuration panel 192. Control then proceeds to block 362 to add the queue wait list to the wait queue panel 182 and return (at block 364) the page to the technical support browser 12a, 12b . . . 12n.

With the above described logic, multiple customers may have their requests added to a queue and receive a customer page 150. The customer page 150 provides an integrated approach to customer support, including access to various on-line resources, such as the knowledge database 24, firmware upgrades, frequently accessed question documents, technical manuals, etc. Additionally, customers can observe their position in a wait queue to better ascertain when they will be serviced. Alternatively, in certain implementations, only the technical support page 180 may include the wait queue panel 182, and the customer page 150 would not. Yet further, with the described implementations, the customer may observe the chat session in the chat panel 154 between a technical support agent and another queued customer. Providing such real-time chats may provide an opportunity for the customer to observe a solution in the chat panel 154 that is directly applicable to their problem. A customer in the wait queue observing a potential solution in the chat panel 154 may then quit the wait queue 32a . . . 32n and attempt to implement the proposed solution. In this way, customers are serviced from the wait queue without having to communicate with the technical support agent, thereby increasing the number of customers whose problems may be serviced by the technical support agent. The customer page 150 may further include a mechanism to allow a customer to signal that they are quitting from the queue, which would cause the transaction manager 20 to dequeue the customer from the wait queue 32a . . . 32n and chat session 40a . . . 40n.

In implementations where wait queues 32a . . . 32n are dedicated to a particular product, the customer problems observed in the chat panel 150 are more likely to be relevant to the problems the queued customers are experiencing. In fact, it has been estimated that 80% of a particular customer's problems are the same problems other customers are experiencing. This percentage may increase if an upgrade to a product is released and numerous customers experience the same problem caused by the upgrade. With the described implementations, the number of technical support agents needed to service customer support requests is minimized because many customer support requests can be serviced from observing solutions discussed in the chat panel 150 or accessed through the other resources panel 162. Customer satisfaction will increase because the number of entries in the wait queues are reduced, thereby reducing the average time a customer must experience before communicating with a technical support agent. Further, customers satisfaction will increase if the customer can implement solutions discussed in the chat panel 154 without having to wait until a technical support agent is available. The described implementations thus utilize the ongoing customer support communications to solve problems for other customers waiting for assistance, thereby reducing customer wait time, the number of customers waiting, and the number of customers that must be serviced directly by a technical support agent.

### Additional Implementation Details

The described customer support system may be implemented as a method, apparatus or article of manufacture using standard programming and/or engineering techniques to produce software, firmware, hardware, or any combination thereof. The term “article of manufacture” as used herein refers to code or logic implemented in hardware logic (e.g., an integrated circuit chip, Programmable Gate Array (PGA), Application Specific Integrated Circuit (ASIC), etc.) or a computer readable medium, such as magnetic storage medium (e.g., hard disk drives, floppy disks,, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.) Code in the computer readable medium is accessed and executed by a processor. The code in which preferred embodiments are implemented may further be accessible through a transmission media or from a file server over a network. In such cases, the article of manufacture in which the code is implemented may comprise a transmission media, such as a network transmission line, wireless transmission media, signals propagating through space, radio waves, infrared signals, etc. Of course, those skilled in the art will recognize that many modifications may be made to this configuration without departing from the scope of the present invention, and that the article of manufacture may comprise any information bearing medium known in the art.

In the described implementations, the customer 150 and technical support 180 pages are implemented as HTML pages for display in a web browser type viewer. Additionally, the pages may be implemented in alternative media formats, such as Extensible Markup Language (XML) pages, Standard Generalized Markup Language (SGML) file, ASCII, etc. The described implementations utilize a browser program, such as a web browser capable of rendering HTML and other markup language content. However, any presentation program capable of rendering content in any media format may be used to render the state changes supplied by the server.

In certain implementations, the customer computer, technical support computer, and customer support server may utilize the Hypertext Transfer Protocol (HTTP) protocol to communicate. In alternative implementations, the computers may use any communication or messaging protocol known in the art to communicate.

The products being serviced through the described customer support server may comprise any type of product or service known in the art, such as computer devices, appliances, home appliances, tools, electronic equipment, machines, vehicles, or any other product or service that may require customer support that consumers are likely to access over a network, such as the Internet.

In the described implementations, the chat session content displayed in the chat panels comprised text entered by the customer and the technical support agent. In alternative implementations, the chat session may be rendered in non-textual formats, such as a multi-media format. For instance, if the customer and technical support agent computers include a microphone, then the chat session content can be rendered as audio output through a speaker at the customer and technical support agent computers. Alternatively, if the customer and technical support agent computers have video cameras, then the chat session content can be rendered as video output. Still further, the content in the customer and technical support page, such as the wait queue, other resources, client configuration information, may be rendered in non-text formats, such as audio, video, etc.

In the described implementations, the chat content was displayed in a chat panel of the page transmitted to the customer browsers. In alternative implementations, the chat content may be displayed in a chat application window separate from the window displaying the customer or technical support page 150 and 180.

The logic of FIGS. 6-9 describes specific operations occurring in a particular order. In alternative implementations, certain of the logic operations may be performed in a different order, modified or removed. Morever, steps may be added to the above described logic and still conform to the preferred embodiments. Further, operations described herein may occur sequentially or certain operations may be processed in parallel. Still further, certain operations may be executed in different computing components or in a same computing component.

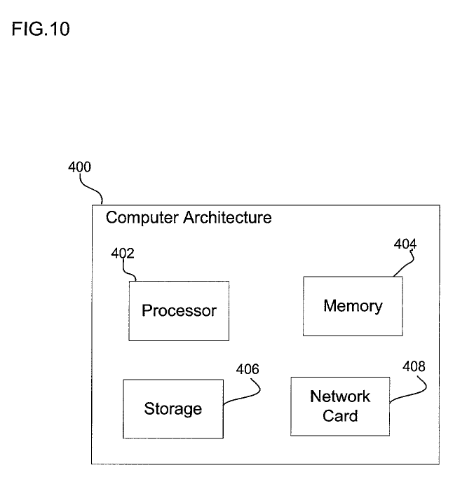

FIG. 10 illustrates one implementation of the architecture of the computer systems 2a, 2b . . . 2n, 20, and 12a, 12b . . . 12n in FIG. 1. The computer systems may implement a computer architecture 400 having a processor 402 (e.g., a microprocessor), a memory 404 (e.g., a volatile memory device), and storage 406 (e.g., a non-volatile storage, such as magnetic disk drives, optical disk drives, a tape drive, etc.). The storage 406 may comprise an internal storage device or an attached or network accessible storage. Programs and data structures, such as the browsers, transaction manager, database application, wait queues, chat sessions 40a . . . 40n, chat server 30, etc., may be maintained in the storage 406 and loaded into the memory 404. The processor 402 may then execute programs and process data structures, where the files and programs may be loaded from storage 406 into the memory 404 for processing. The architecture further includes a network card 408 to enable communication with a network.

In the described implementations, a product vendor maintained the customer support server described herein. Additionally, the customer support system described herein may be utilized by non-vendors, such as technical support companies that provide support for products, yet do not manufacture or sell the product.

The foregoing description of the preferred embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

What is claimed:

1. A method for servicing customer requests for at least one product, comprising:
maintaining at least one queue in a service computer indicating at least one customer requesting product support for the at least one product, wherein requests for customer service are received from customer computers used by customers over a network; and
transmitting to the customer computers of customers indicated in the queue chat session content between a technical support agent and one customer indicated in the queue.

2. The method of claim 1, further comprising:
transmitting over the network a customer page to the customer computers associated with customers indicated in the queue providing customer support information.

3. The method of claim 2, wherein the chat session content is rendered within the customer page rendered on the customer computers.

4. The method of claim 2, further comprising:
including links in the page providing access to customer support resources.

5. The method of claim 4, wherein the customer support resources include at least one of upgrades to apply to the product, a searchable knowledge database, and frequently asked questions.

6. The method of claim 2, further comprising;
generating a list of all customers indicated in the queue; and
transmitting the list to the customer computers associated with customers indicated in the queue, wherein the list is rendered within a panel of the page rendered on the customer computers.

7. The method of claim 1, further comprising;
generating a list of all customers indicated in the queue; and
transmitting the list to the customer computers of customers indicated in the queue, wherein the list is rendered on the customer computers.

8. The method of claim 7, further comprising:
estimating a wait time for each customer indicated in the queue; and
adding the estimated wait time for each customer to the list, wherein the estimated wait times are rendered with the list on the customer computers.

9. The method of claim 1, further comprising:
transmitting an agent page to an agent computer to enable a technical support agent at the agent computer to engage in a chat session with the customer computer of a selected customer indicated in the queue.

10. The method of claim 9, further comprising:
transmitting a list of all customers indicated in the queue to render in the agent page.

11. The method of claim 9, further comprising:
searching a customer database to obtain information on the at least one product for which customer support is requested; and
transmitting the obtained information to the technical support agent computer to render in the agent page.

12. The method of claim 9, wherein the agent page includes a graphical element to enable the technical support agent to transmit an upgrade program directly to the customer computer of the selected customer.

13. The method of claim 1, further comprising:
selecting from the queue one indicated customer;
selecting one technical support agent; and
enabling a chat session between the customer computer of the selected customer and an agent computer of the selected technical support agent, wherein other queued customers can observe the chat session between the selected customer and technical support agent.

14. The method of claim 1, further comprising;
maintaining a plurality of queues in the service computer;
receiving a customer request for product support from one customer computer over the network;
selecting one of the queues; and
adding an entry to the selected queue indicating the customer requesting product support.

15. The method of claim 14, wherein there is at least one queue associated with each of a plurality of products for which customer support is provided, wherein selecting one of the queues comprises:
determining a product indicated in the customer request for product support; and
selecting one queue associated with the determined product.

16. The method of claim 14, wherein there is at least one queue associated with each of a plurality of support levels, wherein selecting one of the queues comprises:
determining one support level associated with the customer initiating the customer request for product support; and
selecting one queue associated with the determined support level.

17. A method for receiving customer support for a product at a customer computer, comprising:
transmitting a request for product support from the customer computer to a service computer over a network; and
receiving in response to the request chat session content between a technical support agent and another customer.

18. The method of claim 17, further comprising:
receiving a customer page providing product support information; and
rendering the customer page on the customer computer, wherein the chat session content is rendered in the customer page.

19. The method of claim 18, further comprising;
receiving a list of all customers that have pending requests for product support for the product; and
rendering the list on the customer computer.

20. A system for servicing customer requests for at least one product over a network, comprising:
means for maintaining at least one queue indicating at least one customer requesting product support for the at least one product, wherein requests for customer service are received from customer computers used by customers over the network; and
means for transmitting to the customer computers of customers indicated in the queue chat session content between a technical support agent and one customer indicated in the queue.

21. The system of claim 20, further comprising:
means for transmitting over the network a customer page to the customer computers associated with customers indicated in the queue providing customer support information.

22. The system of claim 20, further comprising;
means for generating a list of all customers indicated in the queue; and
means for transmitting the list to the customer computers of customers indicated in the queue, wherein the list is rendered on the customer computers.

23. The system of claim 20, further comprising:
means for transmitting an agent page to an agent computer to enable a technical support agent at the agent computer to engage in a chat session with the customer computer of a selected customer indicated in the queue.

24. The system of claim 23, further comprising:
means for searching a customer database to obtain information on the at least one product for which customer support is requested; and
means for transmitting the obtained information to the technical support agent computer to render in the agent page.

25. The system of claim 20, further comprising:
means for selecting from the queue one indicated customer;
means for selecting one technical support agent; and
means for enabling a chat session between the customer computer of the selected customer and an agent computer of the selected technical support agent, wherein other queued customers can observe the chat session between the selected customer and technical support agent.

26. The system of claim 20, further comprising;
means for maintaining a plurality of queues in the service computer;
means for receiving a customer request for product support from one customer computer over the network;
means for selecting one of the queues; and
means for adding an entry to the selected queue indicating the customer requesting product support.

27. A system for receiving customer support for a product over a network, comprising:
means for transmitting a request for product support from the customer computer to a service computer over the network; and
means for receiving in response to the request chat session content between a technical support agent and another customer.

28. The system of claim 27, further comprising:
means for receiving a customer page providing product support information; and
means for rendering the customer page on the customer computer, wherein the chat session content is rendered in the customer page.

29. An article of manufacture for servicing customer requests for at least one product, wherein the article of manufacture causes operations to be performed, the operations comprising:
maintaining at least one queue in a service computer indicating at least one customer requesting product support for the at least one product, wherein requests for customer service are received from customer computers used by customers over a network; and
transmitting to the customer computers of customers indicated in the queue chat session content between a technical support agent and one customer indicated in the queue.

30. The article of manufacture of claim 29, further comprising:
transmitting over the network a customer page to the customer computers associated with customers indicated in the queue providing customer support information.

31. The article of manufacture of claim 30, wherein the chat session content is rendered within the customer page rendered on the customer computers.

32. The article of manufacture of claim 30, further comprising:
including links in the page providing access to customer support resources.

33. The article of manufacture of claim 32, wherein the customer support resources include at least one of upgrades to apply to the product, a searchable knowledge database, and frequently asked questions.

34. The article of manufacture of claim 30, further comprising;
generating a list of all customers indicated in the queue; and
transmitting the list to the customer computers associated with customers indicated in the queue, wherein the list is rendered within a panel of the page rendered on the customer computers.

35. The article of manufacture of claim 29, further comprising;
generating a list of all customers indicated in the queue; and
transmitting the list to the customer computers of customers indicated in the queue, wherein the list is rendered on the customer computers.

36. The article of manufacture of claim 35, further comprising:
estimating a wait time for each customer indicated in the queue; and
adding the estimated wait time for each customer to the list, wherein the estimated wait times are rendered with the list on the customer computers.

37. The article of manufacture of claim 29, further comprising:
transmitting an agent page to an agent computer to enable a technical support agent at the agent computer to engage in a chat session with the customer computer of a selected customer indicated in the queue.

38. The article of manufacture of claim 37, further comprising:
transmitting a list of all customers indicated in the queue to render in the agent page.

39. The article of manufacture of claim 37, further comprising:
searching a customer database to obtain information on the at least one product for which customer support is requested; and
transmitting the obtained information to the technical support agent computer to render in the agent page.

40. The article of manufacture of claim 37, wherein the agent page includes a graphical element to enable the technical support agent to transmit an upgrade program directly to the customer computer of the selected customer.

41. The article of manufacture of claim 29, further comprising:
selecting from the queue one indicated customer;
selecting one technical support agent; and
enabling a chat session between the customer computer of the selected customer and an agent computer of the selected technical support agent, wherein other queued customers can observe the chat session between the selected customer and technical support agent.

42. The article of manufacture of claim 29, further comprising;
maintaining a plurality of queues in the service computer;
receiving a customer request for product support from one customer computer over the network;
selecting one of the queues; and
adding an entry to the selected queue indicating the customer requesting product support.

43. The article of manufacture of claim 42, wherein there is at least one queue associated with each of a plurality of products for which customer support is provided, wherein selecting one of the queues comprises:
determining a product indicated in the customer request for product support; and
selecting one queue associated with the determined product.

44. The article of manufacture of claim 42, wherein there is at least one queue associated with each of a plurality of support level, wherein selecting one of the queues comprises:
determining one support level associated with the customer initiating the customer request for product support; and
selecting one queue associated with the determined support level.

45. An article of manufacture for receiving customer support for a product at a customer computer, wherein the article of manufacture causes operations to be performed, the operations comprising:
transmitting a request for product support from the customer computer to a service computer over a network; and
receiving in response to the request chat session content between a technical support agent and another customer.

46. The article of manufacture of claim 45, further comprising:
receiving a customer page providing product support information; and
rendering the customer page on the customer computer, wherein the chat session content is rendered in the customer page.

47. The article of manufacture of claim 46, further comprising;
receiving a list of all customers that have pending requests for product support for the product; and
rendering the list on the customer computer.
